(19) United States
(12) Patent Application Publication
(10) Pub. No.: US 2025/0389289 A1
(43) Pub. Date: Dec. 25, 2025

(54) Fastening Clip

(71) Applicant: Illinois Tool Works Inc., Glenview, IL (US)

(72) Inventors: Zhilin Li, Shanghai (CN); Jiahui He, Shanghai (CN)

(21) Appl. No.: 19/243,454

(22) Filed: Jun. 19, 2025

(30) Foreign Application Priority Data
Jun. 21, 2024 (CN) 202410813316.6
Jun. 13, 2025 (CN) 202510799162.4
Jun. 13, 2025 (CN) 202521224666.5

(51) Int. Cl. F16B 2/24

(52) U.S. Cl. CPC F16B 2/243

(57) ABSTRACT

The present disclosure provides a fastening clip for connecting a first component to a second component. The fastening clip includes a retaining structure, a beam portion and first and second leg portions. The retaining structure is configured to retain the fastening clip on the first component. The beam portion includes a first end and a second end opposite each other and connected to the retaining structure at the first end thereof. The first and second leg portions are respectively connected to the second end of the beam portion on opposite sides of the beam portion and extend toward the first end. The first and second leg portions are deflectable relative to the beam portion. Each of the first and second leg portions has a blocking portion and an engaging portion. The first and second leg portions are configured to clamp at least part of the second component between the blocking portion and the engaging portion to connect the fastening clip to the second component.

### RELATED APPLICATIONS

The present application claims the benefit of Chinese Patent Application Nos. 202410813316.6, filed Jun. 21, 2024, and 202510799162.4, filed Jun. 13, 2025, and 202521224666.5, filed Jun. 13, 2025, each titled “Fastening Clip,” the contents of which are hereby incorporated by reference.

### TECHNICAL FIELD

The present disclosure relates generally to a fastening clip, and in particular to a fastening clip connecting a first component to a second component.

### BACKGROUND

A fastening clip is used to connect a first component to a second component, with the first component having, for example, a doghouse connection structure, and the second component being, for example, a plate with a hole.

During connection, the fastening clip is first connected into a receiving channel of the first component, and then the fastening clip is inserted into the hole in the second component, thereby achieving the connection of the first component to the second component. The conventional fastening clip suitable for connecting a first component having a doghouse structure is generally made of a plastic material.

### SUMMARY

The present disclosure relates generally to a fastening clip, substantially as illustrated by and described in connection with at least one of the figures, as set forth more completely in the claims.

### DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a fastening clip according to an embodiment of the present disclosure from one perspective.

FIG. 1B is a perspective view of the fastening clip shown in FIG. 1A from another perspective.

FIG. 1C is a side view of the fastening clip shown in FIG. 1A from one perspective.

FIG. 1D is a side view of the fastening clip shown in FIG. 1A from another perspective.

FIG. 2A is a perspective view of the fastening clip shown in FIG. 1A and a first component and a second component fastened thereby.

FIG. 2B is a cross-sectional view of the fastening clip shown in FIG. 1A during the fastening of the first component and the second component.

FIG. 2C is a side view of the fastening clip shown in FIG. 1A when the first component and the second component are fastened in place.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a fastening clip for connecting a first component to a second component. The fastening clip includes a retaining structure, a beam portion and first and second leg portions. The retaining structure is configured to retain the fastening clip on the first component. The beam portion includes a first end and a second end opposite each other and connected to the retaining structure at the first end thereof. The first and second leg portions are respectively connected to the second end of the beam portion on opposite sides of the beam portion and extend toward the first end. The first and second leg portions are deflectable relative to the beam portion. Each of the first and second leg portions has a blocking portion and an engaging portion. The first and second leg portions are configured to clamp at least part of the second component between the blocking portion and the engaging portion to connect the fastening clip to the second component.

In some embodiments, each of the first and second leg portions includes a first leg segment and a second leg segment. The first leg segment and the second leg segment are connected to each other to form the engaging portion at their connection. The first leg segment is connected to the second end of the beam portion, and the blocking portion is connected to the second leg segment. The first leg segment and the second leg segment extend obliquely with respect to the beam portion, with the first leg segment gradually running away from the beam portion in a direction from the second end to the first end, while the second leg segment gradually running toward the beam portion in the direction from the second end to the first end.

In some embodiments, an inclination angle of the second leg segment is greater than an inclination angle of the first leg segment.

In some embodiments, the first and second leg portions each are provided, on a side facing away from the beam portion, with a protrusion extending in a direction of extension thereof.

In some embodiments, each of the first and second leg portions is provided with a receiving hole. The receiving hole is configured to receive at least part of the retaining structure during connection of the first and second leg portions with the second component.

In some embodiments, the receiving hole is provided at least in the blocking portion of each of the first and second leg portions.

In some embodiments, the beam portion includes first and second beams, which are connected to the first and second leg portions, respectively, and are connected to each other between the first end and the second end.

In some embodiments, the first and second beams are connected to each other by at least one connecting tab provided on at least one of the first and second beams.

In some embodiments, the beam portion is provided with guide edges on opposite sides thereof, the guide edges being configured to guide insertion of the first and second leg portions into a hole in the second component.

In some embodiments, the blocking portion includes a tab extending from the second leg segment away from the beam portion.

In some embodiments, the retaining structure includes a head portion and a neck portion between the head portion and the beam portion. The head portion is configured to be inserted into an insertion slot of the first component, and the neck portion is configured to be received in a channel of the first component.

In some embodiments, the fastening clip is integrally formed of a metal sheet.

The fastening clip of the present disclosure is provided with the separate beam portion and leg portions, and achieving connection between the fastening clip and the first component to be fastened with the doghouse connection structure via the retaining structure disposed at one end of the beam portion, while achieving connection between the fastening clip and the second component to be fastened via the leg portions, instead of connecting the fastening clip to both of the first and second components by the leg portions. Thereby, the first and second leg portions, which achieve only the connection with the second component, will not fail to generate a sufficient amount of deflection or interfere with each other due to the limitation of the first component, so that the leg portions, when connected to the hole in the second component, can achieve the desired insertion and extraction force.

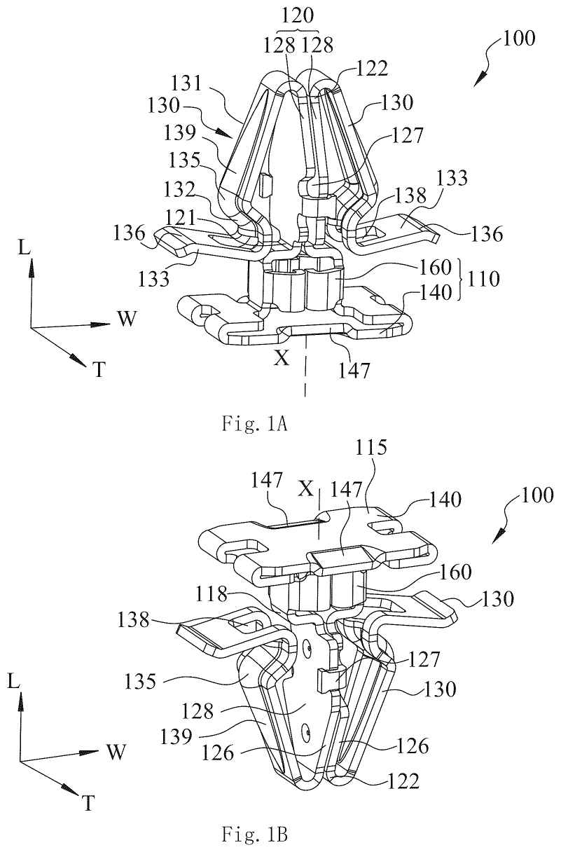

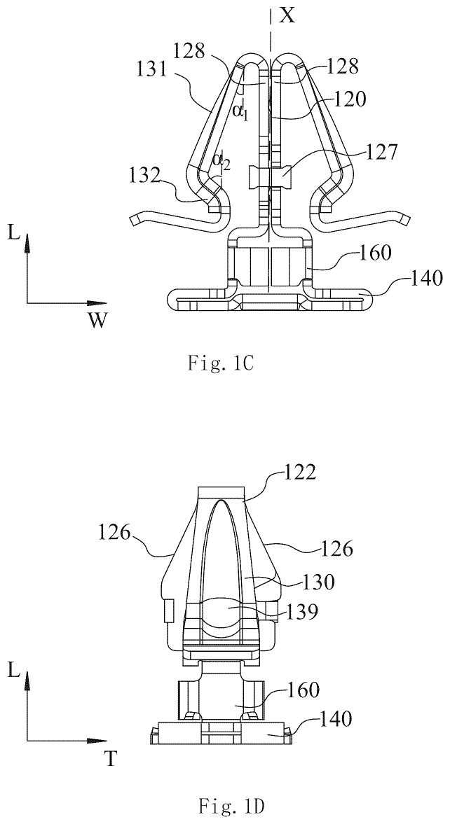

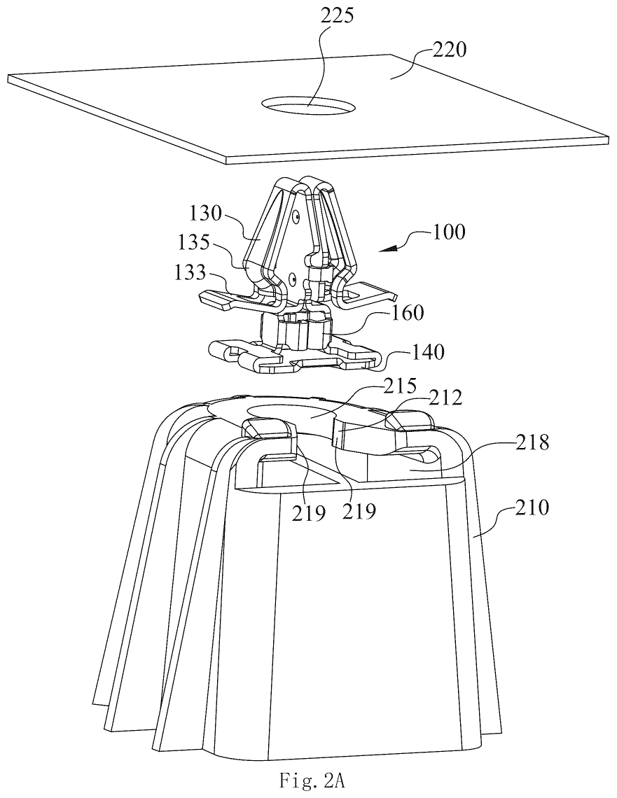

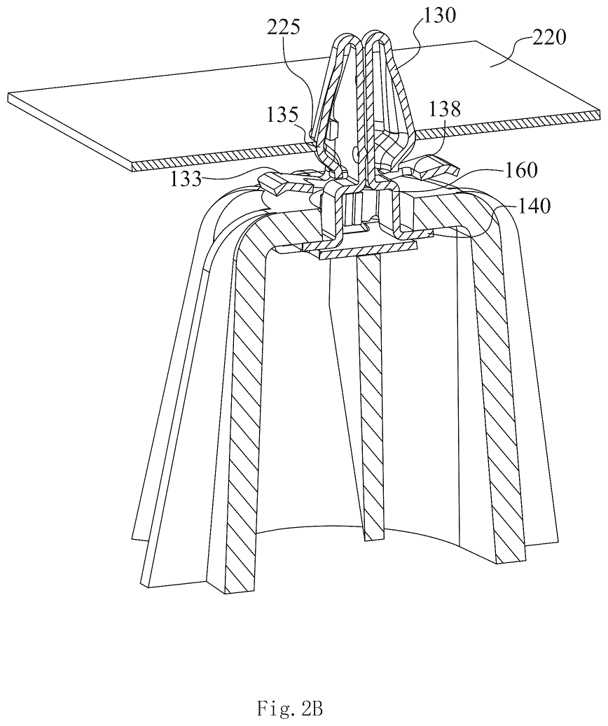

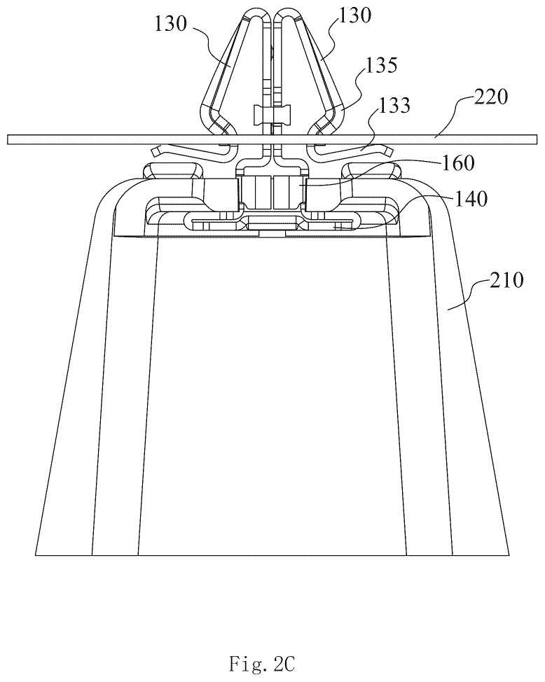

FIGS. 1A-1D illustrate the specific structure of a fastening clip 100 according to an embodiment of the present disclosure. FIGS. 1A and 1B are perspective views of the fastening clip 100 from two different perspectives. FIGS. 1C and 1D are side views of the fastening clip 100 from two different perspectives. The fastening clip 100 is configured to fasten a first component 210 (as shown in FIG. 2A) to a second component 220 (as shown in FIG. 2A).

As shown in FIGS. 1A and 1B, the fastening clip 100 has a length direction L, a width direction W and a thickness direction T, and has an axis X extending in the length direction L thereof. The fastening clip 100 includes a retaining structure 110, a beam portion 120, and first and second leg portions 130. The retaining structure 110 includes a head portion 140 and a neck portion 160. The beam portion 120 extends generally in the length direction L of the fastening clip 100 and includes two opposite axial ends, i.e., a first end 121 and a second end 122. The beam portion 120 is connected to the retaining structure 110 at the first end 121 and to the first and second leg portions 130 at the second end 122. The retaining structure 110 is configured to connect and retain the fastening clip 100 to the first component 210, and the first and second leg portions 130 are configured to connect the fastening clip 100 to the second component 220. The fastening clip 100 is made of a metal material. In some embodiments, the fastening clip 100 is integrally formed by a piece of metal sheet or metal plate through stamping, bending and other processes.

The first and second leg portions 130 are disposed on opposite sides of the beam portion 120 in the width direction W of the fastening clip 100, and extend from the second end 122 toward the first end 121 of the beam portion 120. The first and second leg portions 130 are deflectable relative to the beam portion 120 such that the first and second leg portions 130 are deflectable toward and away from each other so as to be insertable into a hole 225 in the second component 220. In other words, the first and second leg portions 130 are elastic, allowing them to move toward each other under the action of an edge of the hole 225 in the second component 220, and can also spring back when the acting force is removed.

Each leg portion 130 includes a first leg segment 131, a second leg segment 132 and a blocking portion 133. The first leg segment 131 is connected to the second end 122 of the beam portion 120. The first leg segment 131 and the second leg segment 132 are connected to each other. The blocking portion 133 is connected to the second leg segment 132. The first leg segment 131 extends obliquely with respect to the beam portion 120 and gradually runs away from the beam portion 120 in a direction from the second end 122 to the first end 121. The second leg segment 132 extends obliquely with respect to the beam portion 120 and gradually runs toward the beam portion 120 in a direction from the second end 122 to the first end 121. The first leg segment 131 and the second leg segment 132 extend at different inclination angles relative to the beam portion 120. The first leg segment 131 and the second leg segment 132, which are connected to each other, together form a bent shape and form an engaging portion 135 at their connection.

The blocking portion 133 includes a tab extending by a certain length from the second leg segment 132 away from the beam portion 120. Both the blocking portion 133 and the engaging portion 135 are provided on the side of each of the first and second leg portions 130 facing away from the beam portion 120. In the embodiment shown in the figure, the blocking portion 133 extends substantially in the width direction W of the fastening clip 100. Each blocking portion 133 includes a bent portion 136 near a free end thereof, the bent portion 136 being raised toward the first leg segment 131 to abut against one side of the second component 220 after the leg portion 130 is inserted into the hole 225 (as shown in FIG. 2A) in the second component 220.

During insertion of the first and second leg portions 130 into the hole 225 in the second component 220 (as shown in FIG. 2A), the engaging portion 135 of each leg portion is able to pass through the hole 225 in the second component 220 as the first and second leg portions 130 are deflected toward each other, and the blocking portion 133 cannot pass through the hole 225 in the second component 220. That is, the extending length of the blocking portion 133 is set such that when the first and second leg portions 130 are deflected toward each other until the engaging portion 135 is able to pass through the hole 225, the blocking portion 133 is blocked by the second component 220 and cannot pass through the hole 225. Thus, the blocking portion 133 blocks the entirety of the leg portion 130 from passing through the hole 225, and the fastening clip 100 is connected to the second component 220 by the blocking portion 133 and the engaging portion 135 clamping the second component 220 therebetween.

As shown in FIGS. 1A-1C, the beam portion 120 includes first and second beams 128, the first and second beams 128 are connected to the neck portion 160 at the first end 121 and to the first and second leg portions 130 at the second end 122, respectively. The first and second beams 128 extend generally in the length direction L of the fastening clip 100. The first and second beams 128 are adjacent to each other and are connected to each other between the first end 121 and the second end 122. In some embodiments, the first and second beams 128 are each provided with a connecting tab 127, and the two connecting tabs 127 are located on opposite sides of the first and second beams 128. By bending free ends of the two connecting tabs 127, the first and second beams 128 can be connected together. In other embodiments, one connecting tab 127 may be provided only, or more than two connecting tabs 127 may be provided.

As shown in FIGS. 1B and 1D, each of the first and second beams 128 is further provided with guide edges 126 on opposite sides of the fastening clip 100 in the thickness direction T. The guide edges 126 are provided near the second end 122 and extend obliquely with respect to the axis X such that the thickness of each of the first and second beams 128 is gradually reduced near the second end 122. The guide edges 126 are thereby able to guide the first and second leg portions 130 into the hole 225 in the second component 220. The guide edge 126 is arranged between the second end 122 of the beam portion 120 and the connecting tab 127.

As shown in FIGS. 1A and 1B, the head portion 140 is generally in the shape of a flat plate and has bent portions 147. The bent portion 147 is formed by bending at least part of an insertion edge of the head 140 toward the neck 160, serving to protect the first component 210 (FIG. 2A), which for example is made of plastic, from damage by the insertion edge of the head 140 of the fastening clip 100, which is made of metal, when the head 140 is inserted into an insertion slot 218 of the first component 210.

The first and second leg portions 130 each are provided, on a side facing away from the beam portion 120, with a protrusion 139 extending in a direction of extension of the leg portion. The protrusion 139 has a cross-sectional outer contour, for example, of a convex circular shape, to match the shape of the hole 225 in the second component 220 (a circular hole as shown), thereby reducing the insertion force.

As shown in FIG. 1C, in the width direction W of the fastening clip 100, the neck portion 160 is narrower than the head portion 140, so as to form, together with the head portion 140, a T-shaped connector, thereby matching a connection structure of the first component 210 to be connected. Furthermore, in the width direction W of the fastening clip 100, the neck portion 160 is wider than the beam portion 120 to retain the fastening clip 100 more stably on the first component 210. In other embodiments, the retaining structure 110 may not have the neck portion 160, but only the head portion 140, which only requires to extend the beam portion 120.

As still shown in FIGS. 1A and 1B, each of the first and second leg portions 130 is provided with a receiving hole 138 therethrough for receiving at least part of the neck portion 160 during insertion of the first and second leg portions 130 into the hole 225 in the second component 220, thereby avoiding interference of the neck portion 160 with the leg portion 130, and allowing the first and second leg portions 130 to deflect toward each other until their engaging portion 135 is able to pass through the hole 225 in the second component 220. In some embodiments, the receiving hole 138 is formed in the blocking portion 133 of the leg portion 130. In other embodiments, the receiving hole 138 may also extend from the blocking portion 133 of the leg portion 130 into the second leg segment 132.

As shown in FIG. 1C, the first leg segment 131 and the second leg segment 132 extend obliquely at different angles relative to the first and second beams 128 and to the axis X. The inclination angle of the first leg segment 131 with respect to the first and second beams 128 and the axis X is α1, and the inclination angle of the second leg segment 132 with respect to the first and second beams 128 and the axis X is α2, where α2>α1.

In the embodiment shown in FIGS. 1A-1C, the fastening clip 100 is generally symmetrical about the axis X.

As shown in FIG. 1D, in the thickness direction T of the fastening clip 100, the first and second beams 128 extend beyond the leg portions 130 so that the guide edges 126 of the first and second beams 128 are located outside the leg portions 130. The guide edges 126 engage with the edge of the hole 225 in the second component 220 such that the leg portions 130 are centrally located relative to the hole 225 when inserted into the hole, so that the leg portions 130 are uniformly stressed and can be mounted in place smoothly.

FIGS. 2A-2C illustrate the process by which the fastening clip 100 secures the first component 210 to the second component 220. FIG. 2A is a perspective view of the fastening clip 100, the first component 210 and the second component 220; FIG. 2B is a cross-sectional view of the fastening clip 100 during the fastening of the first component 210 and the second component 220; and FIG. 2C is a side view of the fastening clip 100 fastening the first component 210 and the second component 220 in place.

As shown in FIG. 2A, the fastening clip 100 is configured to fasten the first component 210 to the second component 220. The second component 220 is a plate having a hole 225, the hole 225 is a circular hole. In other embodiments, the hole 225 may not be a circular hole. The first component 210 is a component with a doghouse connection portion for mating connection with a fastening member with a T-shaped connector. Specifically, the first component 210 includes a receiving channel 215 and an insertion slot 218 located below the receiving channel 215. The receiving channel 215 has an opening 212 to allow the fastening component to pass through the opening 212 into the receiving channel 215. The width of the opening 212 is less than the radial dimension of the receiving channel 215. The first component 210 is made of a plastic material, a pair of side walls 219 defining the opening 212 may move away from each other when subjected to a certain acting force, so as to enlarge the opening 210, and when the acting force is removed, the pair of side walls 219 can spring back to an initial position.

As shown in FIGS. 2A to 2C, the fastening clip 100 is first connected to the first component 210 during the fastening process. When the fastening clip 100 is connected to the first component 210, the head portion 140 and neck portion 160 of the fastening clip 100 are aligned with the insertion slot 218 and the opening 212 of the first component 210, respectively, and the neck portion 160 pushes the pair of side walls 219 of the opening 212 to enlarge the opening 212. The neck portion 160 then enters the receiving channel 215 and the head portion 140 enters the insertion slot 218, and the pair of side walls 219 of the opening 212 spring back, retaining the neck portion 160 in the receiving channel 215. Thus, the fastening clip 100 is connected and retained on the first component 210.

Thereafter, as shown in FIG. 2B, the leg portions 130 of the fastening clip 100 are inserted into the hole 225 in the second component 220.

Since the first and second leg portions 130 are elastic, they deflect toward each other under the action of the edge of the hole 225, the engaging portions 135 of the first and second leg portions 130 can pass through the hole 225 and cooperate with the blocking portions 133 which cannot pass through the hole 225, to retain the first and second leg portions 130 on the second component 220, achieving the connection of the first and second leg portions 130 with the second component 220. Thus, the first component 210 is fastened to the second component 220 by the fastening clip 100, as shown in FIG. 2C.

As shown in FIG. 2B, when the engaging portions 135 of the first and second leg portions 130 pass through the hole 225 in the second component 220, the amplitude of the first and second leg portions 130 moving toward each other is maximum, but since the part of the neck portion 160 on a path of movement of the leg portion 130 can be received by the receiving hole 138 in the leg portion 130, the neck portion 160 does not interfere with the movement of the leg portion 130.

The fastening clip of the present disclosure is provided with the separate beam portion and leg portions, and achieving connection between the fastening clip and the first component to be fastened with the doghouse connection structure via the retaining structure disposed at one end of the beam portion, while achieving connection between the fastening clip and the second component to be fastened via the leg portions, instead of connecting the fastening clip to both of the first and second components by the leg portions. Thereby, the first and second leg portions, which achieve only the connection with the second component, will not fail to generate a sufficient amount of deflection or interfere with each other due to the limitation of the first component, so that the leg portions, when connected to the hole in the second component, can achieve the desired insertion and extraction force, thereby making it easier for the leg portions to be inserted into the hole in the second component to achieve fastening. Moreover, it is not easy for the leg portions to unintentionally come out of the hole in the second component when it is in the fastened state. Furthermore, the fastening clip of the present disclosure can be connected to the second component by the leg portions only, without the need of using the leg portions and the head portion together to connect the fastening clip to the second component, which also facilitates the desired insertion force of the leg portions when connected to the hole in the second component.

Furthermore, in the fastening clip of the present disclosure, inclination angles of the two leg segments, i.e., the second leg segment close to the plate and the first leg segment away from the plate, with respect to the beam portion are set to be different such that the inclination angle of the second leg segment is greater than the inclination angle of the first leg segment, thereby further reducing the force required to insert the fastening clip into the plate, and increasing the force required to pull the fastening clip out of the plate.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting. Therefore, the present disclosure in this specification may be used to solve other technical problems and may have other technical effects. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

### REFERENCE NUMBERS

Fastening clip 100
Retaining structure 110
Beam portion 120
First end 121
Second end 122
Guide edge 126
Connecting tab 127
First and second beams 128
First and second leg portions 130
First leg segment 131
Second leg segment 132
Blocking portion 133
Engaging portion 135
Bent portion 136
Receiving hole 138
Protrusion 139
Head portion 140
Bent portion 147
Neck portion 160
First component 210
Opening 212
Receiving channel 215
Insertion slot 218
Side wall 219
Second component 220
Hole 225

What is claimed is:

1. A fastening clip for connecting a first component to a second component, the fastening clip comprising:
a retaining structure configured to retain the fastening clip on the first component;
a beam portion comprising a first end and a second end opposite each other and connected to the retaining structure at the first end thereof; and
first and second leg portions respectively connected to the second end of the beam portion on opposite sides of the beam portion and extending toward the first end, the first and second leg portions being deflectable relative to the beam portion,
wherein each of the first and second leg portions has a blocking portion and an engaging portion, the first and second leg portions are configured to clamp at least part of the second component between the blocking portion and the engaging portion to connect the fastening clip to the second component.

2. The fastening clip according to claim 1,
wherein each of the first and second leg portions comprises a first leg segment and a second leg segment, the first leg segment and the second leg segment being connected to each other to form the engaging portion at their connection, wherein the first leg segment is connected to the second end of the beam portion, and the blocking portion is connected to the second leg segment, and
wherein the first leg segment and the second leg segment extend obliquely with respect to the beam portion, with the first leg segment gradually running away from the beam portion in a direction from the second end to the first end, while the second leg segment gradually running toward the beam portion in the direction from the second end to the first end.

3. The fastening clip according to claim 2, wherein an inclination angle of the second leg segment is greater than an inclination angle of the first leg segment.

4. The fastening clip according to claim 1, wherein the first and second leg portions each are provided, on a side facing away from the beam portion, with a protrusion extending in a direction of extension thereof.

5. The fastening clip according to claim 1, wherein each of the first and second leg portions is provided with a receiving hole, the receiving hole being configured to receive at least part of the retaining structure during connection of the first and second leg portions with the second component.

6. The fastening clip according to claim 5, wherein the receiving hole is provided at least in the blocking portion of each of the first and second leg portions.

7. The fastening clip according to claim 1, wherein the beam portion comprises first and second beams, which are connected to the first and second leg portions, respectively, and are connected to each other between the first end and the second end.

8. The fastening clip according to claim 7, wherein the first and second beams are connected to each other by at least one connecting tab provided on at least one of the first and second beams.

9. The fastening clip according to claim 1, wherein the beam portion is provided with guide edges on opposite sides thereof, the guide edges being configured to guide insertion of the first and second leg portions into a hole in the second component.

10. The fastening clip according to claim 1, wherein the blocking portion comprises a tab extending from the second leg segment away from the beam portion.

11. The fastening clip according to claim 1, wherein the retaining structure comprises:
a head portion; and
a neck portion between the head portion and the beam portion,
wherein the head portion is configured to be inserted into an insertion slot of the first component, and the neck portion is configured to be received in a channel of the first component.

12. The fastening clip according to claim 1, wherein the fastening clip is integrally formed of a metal sheet.
